(19) United States
(12) Patent Application Publication
(10) Pub. No.: US 2024/0016210 A1
(43) Pub. Date: Jan. 18, 2024

(54) ELECTRONIC VAPORIZATION DEVICE

(71) Applicant: SHENZHEN FIRST UNION TECHNOLOGY CO., LTD., Shenzhen City, Guangdong Proving (CN)

(72) Inventors: WEIFENG GONG, Shenzhen City, Guangdong Province (CN); ZHONGLI XU, Shenzhen City, Guangdong Province (CN); YONGHAI LI, Shenzhen City, Guangdong Province (CN)

(21) Appl. No.: 18/037,321

(22) PCT Filed: Nov. 16, 2021
(86) PCT No.: PCT/CN2021/131008

§ 371 Date: May 16, 2023

(30) Foreign Application Priority Data
Nov. 16, 2020 (CN) 202022641642.3

(51) Int. Cl. A24F 40/46; A24F 40/10; A24F 40/48; A24F 40/42; A24F 40/50; H05B 3/22

(52) U.S. Cl. CPC A24F 40/46; A24F 40/10; A24F 40/48; A24F 40/42; A24F 40/50; H05B 3/22

(57) ABSTRACT

An electronic vaporization device includes a shell; a vaporizer, including a liquid storage unit configured to store a liquid, and a vaporization core configured to heat the liquid to generate an aerosol; a battery; a circuit board, including a first electrical contact portion and a second electrical contact portion; a first conductive connector, where an end of the first conductive connector abuts against the vaporization core to form an electrical connection, and the other end of the first conductive connector abuts against the first electrical contact portion to form an electrical connection; and a second conductive connector, spaced apart from the first conductive connector, where an end of the second conductive connector abuts against the vaporization core to form an electrical connection, and the other end of the second conductive connector abuts against the second electrical contact portion to form an electrical connection.

### CROSS-REFERENCE TO RELATED APPLICATION

This application claims priority to Chinese Patent Application No. 202022641642.3, entitled “ELECTRONIC VAPORIZATION DEVICE” and filed with the China National Intellectual Property Administration on Nov. 16, 2020, which is incorporated herein by reference in its entirety.

### TECHNICAL FIELD

This application relates to the technical field of cigarette devices, and in particular, to an electronic vaporization device.

### BACKGROUND

An electronic vaporization device is an electronic product that heats an e-liquid to generate an aerosol for a user to inhale, and usually has two parts: a vaporizer and a power supply component. The vaporizer stores an e-liquid inside and is provided with a vaporization core configured to heat the e-liquid. The power supply component includes a battery and a circuit board. The power supply component can supply power to the vaporization core, so that the vaporization core generates heat and has a high temperature to heat the e-liquid.

Generally, a circuit connection manner of the electronic vaporization device is as follows. Positive and negative electrodes of the battery are respectively connected to the circuit board, the circuit board is connected to two pogo pins, the two pogo pins are respectively connected to two electrode terminals of the vaporizer, and the two electrode terminals are connected to the vaporization core, so as to supply electric energy to the vaporization core for a heating element in the vaporization core to generate heat, and control a working status of the vaporizer through the circuit board.

A problem in the existing electronic vaporization device lies in that, a design of two pogo pins and two electrode terminals results in more assembly procedures, which are not conducive to automatic production.

### SUMMARY

This application provides an electronic vaporization device, to resolve a problem that an existing electronic vaporization device has many assembly procedures, which is not conducive to automatic production.

This application provides an electronic vaporization device, including:
a shell;
a vaporizer, at least partially arranged in the shell, where the vaporizer includes a liquid storage unit configured to store a liquid, and a vaporization core configured to heat the liquid to generate an aerosol;
a battery, arranged in the shell;
a circuit board, arranged in the shell and electrically connected to the battery, where the circuit board includes a first electrical contact portion and a second electrical contact portion;
a first conductive connector, where an end of the first conductive connector abuts against the vaporization core to form an electrical connection, and the other end of the first conductive connector abuts against the first electrical contact portion to form an electrical connection; and
a second conductive connector, spaced apart from the first conductive connector, where an end of the second conductive connector abuts against the vaporization core to form an electrical connection, and the other end of the second conductive connector abuts against the second electrical contact portion to form an electrical connection.

In the electronic vaporization device provided in this application, the first conductive connector and the second conductive connector abut against the vaporization core and the circuit board to form an electrical connection. The electronic vaporization device has a simple structure and fewer assembly procedures, which is conducive to automatic production.

### BRIEF DESCRIPTION OF THE DRAWINGS

The objective implementation, functional features and advantages of this application are further illustrated with reference to the accompanying drawings by using the embodiments. One or more embodiments are exemplarily described with reference to the corresponding figures in the accompanying drawings, and the descriptions do not constitute a limitation to the embodiments. Components in the accompanying drawings that have same reference numerals are represented as similar components, and unless otherwise particularly stated, the figures in the accompanying drawings are not drawn to scale.

FIG. 1 is a schematic diagram of an electronic vaporization device according to an embodiment of this application;

FIG. 2 is a schematic exploded view of an electronic vaporization device according to an embodiment of this application;

FIG. 3 is a schematic cross-sectional view of a vaporizer in an electronic vaporization device according to an embodiment of this application;

FIG. 4 is a schematic diagram of a vaporization core in a vaporizer according to an embodiment of this application;

FIG. 5 is a schematic diagram of a fixing base in a vaporizer according to an embodiment of this application;

FIG. 6 is a schematic cross-sectional view of an electronic vaporization device according to an embodiment of this application; and

FIG. 7 is a schematic diagram of a circuit board in an electronic vaporization device according to an embodiment of this application.

### DETAILED DESCRIPTION

It is to be understood that the specific embodiments described herein are merely used for explaining this application but are not intended to limit this application. For ease of understanding of this application, this application is described in further detail below with reference to the accompanying drawings and specific implementations. It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as that usually understood by a person skilled in the technical field to which this application belongs. The terms used in this specification of this application are merely intended to describe objectives of the specific implementations, and are not intended to limit this application. The term “and/or” used in this specification includes any or all combinations of one or more related listed items.

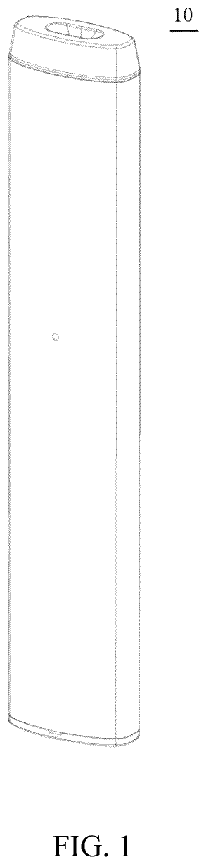

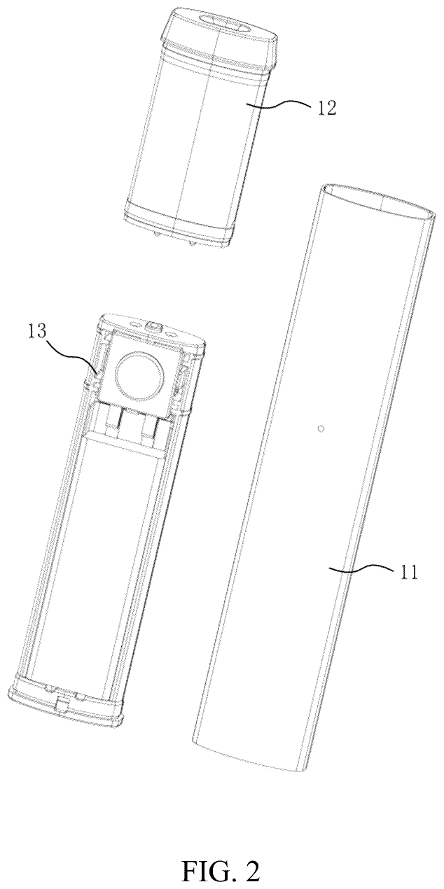

As shown in FIG. 1 and FIG. 2, an electronic vaporization device 10 includes a shell 11, a vaporizer 12, and a power supply component 13.

The shell 11 is hollow inside, and has a first opening end and a second opening end. The vaporizer 12 is at least partially accommodated in the shell 11 from the first opening end, and the power supply component 13 is at least partially accommodated in the shell 11 from the second opening end. Specifically, the vaporizer 12 is detachably connected at the first opening end, and the power supply component 13 is detachably connected at the second opening end. In another example, it is also feasible that the shell 11, the vaporizer 12, and the power supply component 13 may be designed as a unity.

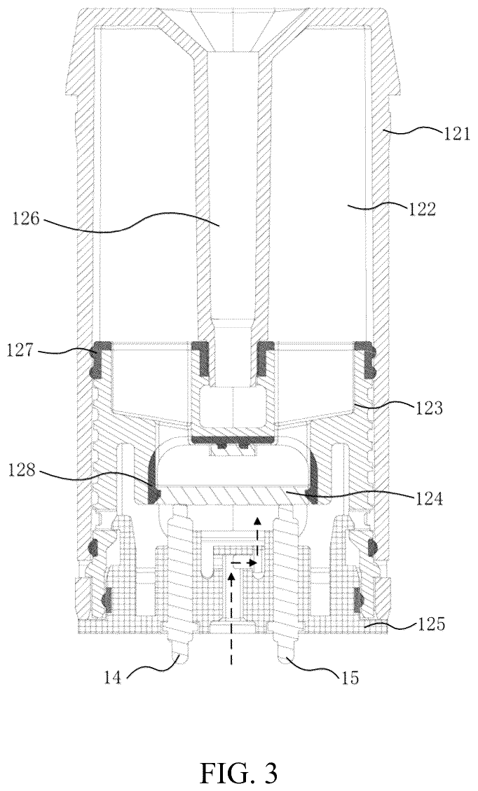

As shown in FIG. 3, the vaporizer 12 includes a vaporization shell 121, a liquid storage unit 122, a base 123, a vaporization core 124, a fixing base 125, and an air outlet channel 126.

The vaporization shell 121 has a suction nozzle end and an opening end. The base 123 is configured to hold the vaporization core 124. The base 123 holds the vaporization core 124 and then is accommodated in the vaporization shell 121 through the opening end of the vaporization shell 121, and the base 123 is in a buckle connection with the vaporization shell 121. The liquid storage unit 122 is formed between the base 123 and an inner wall of the vaporization shell 121, and is configured to store a liquid that can generate an aerosol. The inner wall of the vaporization shell 121 forms at least a part of the air outlet channel 126, an end of the air outlet channel 126 is in communication with the suction nozzle end, and the other end of the air outlet channel 126 is held on the base 123. In another example, it is also feasible to form the air outlet channel 126 in a form of an independent hollow tube.

The liquid may be a liquid that includes a tobacco-containing substance having a volatile tobacco-flavor component, and may also be a liquid that includes a non-tobacco substance. For example, the liquid may include water, a solvent, ethanol, a plant extract, a fragrance, a flavoring agent, or a vitamin mixture. The fragrance may include, but is not limited to, menthol, peppermint, spearmint oil, various fruit-flavor components, and the like. The flavoring agent may include components that can provide various fragrances or flavors for a user. The vitamin mixture may be, but is not limited to, a mixture of at least one of vitamin A, vitamin B, vitamin C, and vitamin E. In addition, the liquid may include aerosol-forming agents, such as glycerol and propylene glycol.

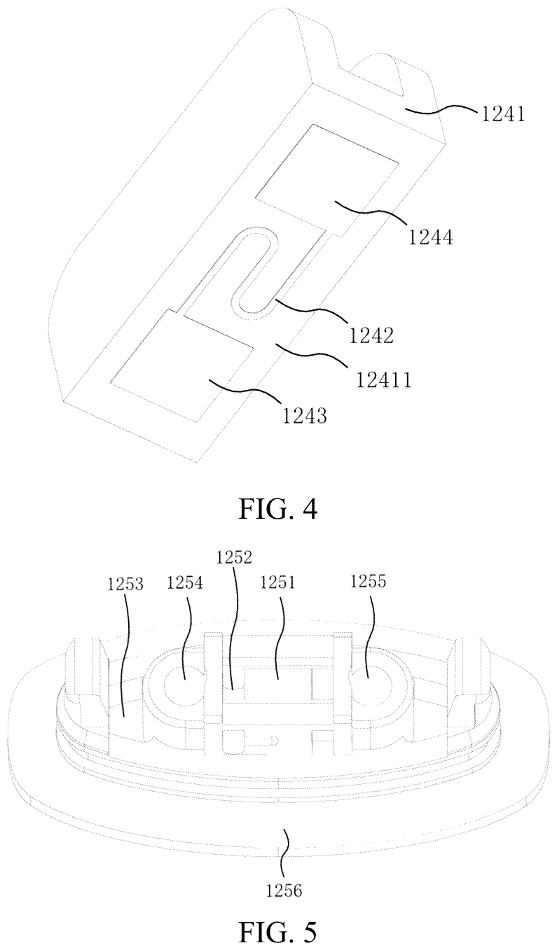

Referring to FIG. 4, the vaporization core 124 includes a porous substrate 1241 and a heating element 1242. The heating element 1242 is arranged on the porous substrate 1241. For example, the heating element 1242 may be arranged on an outer surface of the porous substrate 1241, and may also be arranged inside the porous substrate 1241 through integrally forming. In this example, the heating element 1242 is preferably a printed circuit, and is arranged on a bottom surface 12411 of the porous substrate 1241 through screen printing. The porous substrate 1241 is made of a porous material, such as porous ceramic, porous glass ceramic, or porous glass.

The fixing base 125 is in a buckle connection with the base 123, and is partially accommodated in the vaporization shell 121 through the opening end of the vaporization shell 121. The fixing base 125 is positioned inside the shell 11, to form a first cavity and a second cavity on two sides of the fixing base 125. The vaporization core 124 is arranged in the first cavity. The power supply component 13 is arranged in the second cavity. A part of the vaporization shell 121 is accommodated in the first cavity, and the vaporization core 124 is arranged between the liquid storage unit 122 and the fixing base 125.

Specifically, referring to FIG. 5, the fixing base 125 includes an air inlet channel (not shown), a blocking portion 1251, a liquid delivery channel 1252, a condensing cavity 1253, a first through hole 1254, a second through hole 1255, and a step 1256.

Referring to FIG. 3, the air inlet channel is configured to guide air in the second cavity to flow into the first cavity, that is, flow into the vaporization core 124. The blocking portion 1251 is configured to block the air inlet channel, to prevent a condensed liquid from entering the second cavity through the air inlet channel. Because of a blocking function of the blocking portion 1251, external air forms a bent airflow path (as shown by a dashed-line arrow in FIG. 3) when flowing to the vaporization core 124 through the air inlet channel. An end of the liquid delivery channel 1252 is closed, and the other end is in fluid communication with the condensing cavity 1253. Because of the blocking function of the blocking portion 1251, the condensed liquid cannot flow into the air inlet channel, then flows to the liquid delivery channel 1252, and flows into the condensing cavity 1253 through the liquid delivery channel 1252 to be collected.

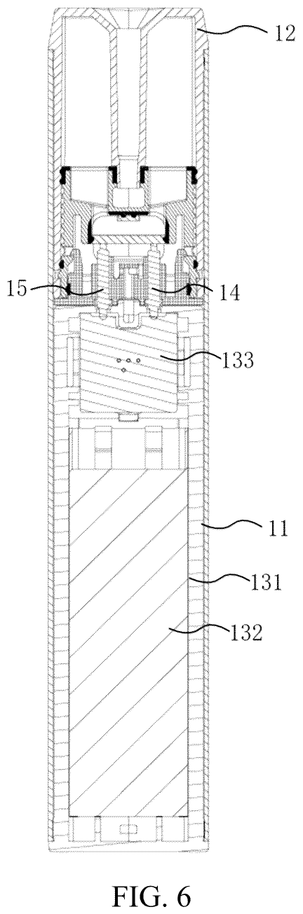

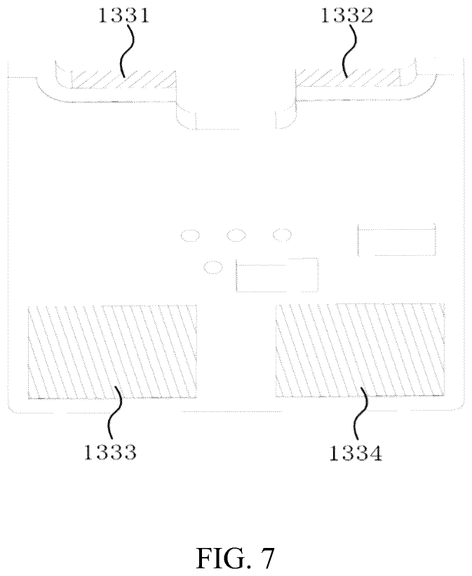

The electronic vaporization device 10 further includes a first conductive connector 14 and a second conductive connector 15. The first conductive connector 14 is mounted in the first through hole 1254, and two ends of the first conductive connector 14 respectively extend out of the first through hole 1254. The second conductive connector 15 is mounted in the second through hole 1255, and two ends of the second conductive connector 15 respectively extend out of the second through hole 1255. Referring to FIG. 6 and FIG. 7, the vaporization core 124 further includes an electrical contact portion 1243 and an electrical contact portion 1244 that are arranged on the bottom surface 12411, and the circuit board 133 includes an electrical contact portion 1331 and an electrical contact portion 1332. After the two ends of the first conductive connector 14 respectively extend out of the first through hole 1254, one end abuts against the electrical contact portion 1243 to form an electrical connection, and the other end abuts against the electrical contact portion 1331 to form an electrical connection. After the two ends of the second conductive connector 15 respectively extend out of the second through hole 1255, one end abuts against the electrical contact portion 1244 to form an electrical connection, and the other end abuts against the electrical contact portion 1332 to form an electrical connection.

When a part of the fixing base 125 is accommodated in the vaporization shell 121 through the opening end of the vaporization shell 121, the opening end of the vaporization shell 121 abuts against the step 1256.

Further, still referring to FIG. 3, the vaporizer 12 further includes a first seal member 127 and a second seal member 128. The first seal member 127 is arranged between the base 123 and the inner wall of the vaporization shell 121, to prevent a liquid in the liquid storage unit 122 from flowing out through a gap between the base 123 and the inner wall of the vaporization shell 121. The second seal member 128 is arranged between the vaporization core 124 and the base 123, to prevent a liquid from flowing out through a gap between the vaporization core 124 and the base 123.

It should be noted that, in other examples, it is also feasible that the base 123, the vaporization core 124, the fixing base 125, the first seal member 127, and the second seal member 128 may be designed as a unity.

Referring to FIG. 6, the power supply component 13 includes a holder 131, a battery 132, and a circuit board 133. The battery 132 and the circuit board 133 are fixed on the holder 131, and the circuit board 133 is arranged over the battery 132 and adjacent to the vaporizer 12. After the battery 132 and the circuit board 133 are fixed on the holder 131, the holder 131 is detachably connected at the second opening end.

The circuit board 133 may control an overall operation by the electronic vaporization device. To be specific, the circuit board 133 not only controls operations by the battery 132 and the vaporization core 124, but also controls operations by other elements in the electronic vaporization device. For example, the circuit board 133 may determine, by checking a status of a microphone, whether the electronic vaporization device can perform a start operation, or the circuit board 133 may control an operation by a display apparatus based on a status of the vaporization core 124.

Referring to FIG. 7, the circuit board 133 has an upper surface and a lower surface that are opposite to each other in a length direction of the electronic vaporization device 10. The upper surface is arranged adjacent to the vaporizer 12, and the electrical contact portion 1331 and the electrical contact portion 1332 are arranged on the upper first surface, so as to be in contact with the first conductive connector 14 and the second conductive connector 15 to form an electrical connection. To facilitate contact to form an electrical connection, gold plating may be performed on the electrical contact portion 1331 and the electrical contact portion 1332. The electrical contact portion 1331 and the electrical contact portion 1332 may also be printed on a conductive layer of the circuit board 133.

The circuit board 133 further has a front surface and a rear surface that are opposite to each other in a thickness direction of the electronic vaporization device 10. A pad 1333 and a pad 1334 are arranged on the front surface. The circuit board 133 is welded to the battery 132 through the pad 1333 and the pad 1334. It is easy to imagine that the pads may also be arranged on the rear surface to be welded to the battery 132.

It should be noted that, the specification of this application and the accompanying drawings thereof illustrate preferred embodiments of this application. However, this application may be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the foregoing technical features are further combined to form various embodiments not listed above, and all such embodiments shall be construed as falling within the scope of this application. Further, a person of ordinary skill in the art may make improvements or modifications according to the foregoing description, and all the improvements and modifications shall fall within the protection scope of the attached claims of this application.

1. An electronic vaporization device, comprising:
a shell;
a vaporizer, at least partially arranged in the shell, wherein the vaporizer comprises a liquid storage unit configured to store a liquid, and a vaporization core configured to heat the liquid to generate an aerosol;
a battery, arranged in the shell;
a circuit board, arranged in the shell and electrically connected to the battery, wherein the circuit board comprises a first electrical contact portion and a second electrical contact portion;
a first conductive connector, wherein an end of the first conductive connector abuts against the vaporization core to form an electrical connection, and the other end of the first conductive connector abuts against the first electrical contact portion to form an electrical connection; and
a second conductive connector, spaced apart from the first conductive connector, wherein an end of the second conductive connector abuts against the vaporization core to form an electrical connection, and the other end of the second conductive connector abuts against the second electrical contact portion to form an electrical connection.

2. The electronic vaporization device according to claim 1, wherein the electronic vaporization device further comprises a fixing base, and the fixing base comprises a first through hole and a second through hole;
the first conductive connector is mounted in the first through hole, and two ends of the first conductive connector respectively extend out of the first through hole; and the second conductive connector is mounted in the second through hole, and two ends of the second conductive connector respectively extend out of the second through hole.

3. The electronic vaporization device according to claim 2, wherein the fixing base is positioned inside the shell, to form a first cavity and a second cavity on two sides of the fixing base, the vaporization core is arranged in the first cavity, and the circuit board and the battery are arranged in the second cavity.

4. The electronic vaporization device according to claim 3, wherein the fixing base further comprises an air inlet channel and a blocking portion;
the air inlet channel is configured to guide air in the second cavity to flow into the first cavity; and the blocking portion is configured to block the air inlet channel, to prevent a condensed liquid from entering the second cavity through the air inlet channel.

5. The electronic vaporization device according to claim 4, wherein the fixing base further comprises a condensing cavity configured to collect a condensed liquid.

6. The electronic vaporization device according to claim 3, wherein the vaporizer further comprises a vaporization shell, a part of the vaporization shell is accommodated in the first cavity, and the fixing base is arranged at an end of the vaporization shell and is partially inserted into the vaporization shell; and
a part of a space between an inner wall of the vaporization shell and the fixing base forms the liquid storage unit, and the vaporization core is arranged between the liquid storage unit and the fixing base.

7. The electronic vaporization device according to claim 1, wherein the vaporization core comprises a porous substrate and a heating element arranged on the porous substrate; and
an end of the first conductive connector and an end of the second conductive connector respectively abut against the heating element to form an electrical connection.

8. The electronic vaporization device according to claim 1, wherein the circuit board comprises a first surface and a second surface that are opposite to each other in a length direction of the electronic vaporization device, the first surface is arranged adjacent to the vaporizer, and the first electrical contact portion and the second electrical contact portion are arranged on the first surface.

9. The electronic vaporization device according to claim 8, wherein the circuit board further comprises a third surface and a fourth surface that are opposite to each other in a thickness direction of the electronic vaporization device, and a pad is arranged on the third surface or the fourth surface; and the circuit board is welded to the battery through the pad.

10. The electronic vaporization device according to claim 1, wherein the shell comprises a first opening end and a second opening end; the electronic vaporization device further comprises a holder configured to mount the circuit board and the battery; and
the vaporizer is at least partially accommodated in the shell from the first opening end, and the holder is at least partially accommodated in the shell from the second opening end.
